(19) United States
(12) Patent Application Publication
(10) Pub. No.: US 2007/0295651 A1
(43) Pub. Date: Dec. 27, 2007

(54) Dialysis bag system

(76) Inventors: F. Jesus Martinez, Mission Viejo, CA (US); Virginia Thanh Ta, Santa Ana, CA (US)

Correspondence Address: AVERILL & VARN, 8244 PAINTER AVE., WHITTIER, CA, 90602, US

(21) Appl. No.: 11/475,467

(22) Filed: Jun. 26, 2006

(51) Int. Cl. B01D 63/00

(52) U.S. Cl. 210/143; 210/321.6; 210/646; 210/195.2; 210/134

(57) ABSTRACT

A disposable mass transfer system includes a source of dialysis fluid, a waste fluid reservoir, at least one semi-permeable tubular membrane residing in at least one fluid flow channel carrying a flow of a dialysis fluid, and a configurable pump and tubing. The pump and tubing may be configured to pump fresh dialysis fluid into the fluid flow channel, or may be configured to re-circulate partially spent dialysis fluid through the fluid flow channel. The fluid flow channel may be the interior of a flexible sealed reservoir, or may be a semi-rigid or rigid tubular enclosure.

### BACKGROUND OF THE INVENTION

The present invention relates to dialysis systems and in particular to a self-contained mass transfer system including a semi-permeable tubular membrane residing in a flexible dialysis chamber.

### BRIEF SUMMARY OF THE INVENTION

The present invention addresses the above and other needs by providing a disposable mass transfer system which includes a source of dialysis fluid, a waste fluid reservoir, at least one semi-permeable tubular membrane residing in at least one fluid flow channel carrying a flow of a dialysis fluid, and a configurable pump and tubing. The pump and tubing may be configured to pump fresh dialysis fluid into the fluid flow channel, or may be configured to re-circulate partially spent dialysis fluid through the fluid flow channel. The fluid flow channel may be the interior of a flexible sealed reservoir, or may be a semi-rigid or rigid tubular enclosure.

In accordance with one aspect of the invention, there is provided a disposable dialysis system including two sequentially connected fluid flow channels having an inlet port and an outlet port, two semi-permeable membranes, one residing substantially within each of the fluid flow channels, a dialysis fluid source, and a spent dialysis fluid reservoir. The semi-permeable membranes have an exposed end having a port which provides access to an interior of the semi-permeable membranes. Inlet tubes fluidly connecting the dialysis fluid source to the inlet port, outlet tubes fluidly connect the outlet port and the spent dialysis fluid reservoir, and a shunt tube is fluidly connected between the inlet tubes and the outlet tubes by a first “T” residing in series with the inlet tubes and a second “T” residing in series with the outlet tubes. A pump resides between one of the “T”s and either the inlet port or the outlet port. A first on/off valve cooperating with the inlet tubes between the dialysis fluid source and the first “T” to control an inlet flow, a second on/off valve cooperating with the outlet tubes between the second “T” and the spent dialysis fluid reservoir to control an outlet flow, and a third on/off valve cooperating with the shunt tube between the “T”s to control a shunt flow. The pump cooperates with the inlet tubes or the outlet tubes to provide propulsion to dialysis fluid in the tubes.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a disposable mass transfer system according to the present invention having a flexible sealed reservoir.

FIG. 2 is a second embodiment of the disposable mass transfer system according to the present invention having two semi-rigid or rigid tubular enclosures connected by flexible tubing.

FIG. 3 is a third embodiment of the disposable mass transfer system according to the present invention having two semi-rigid or rigid tubular enclosures connected by elbows.

FIG. 4 is a fourth embodiment of the disposable mass transfer system according to the present invention having one semi-rigid or rigid tubular enclosure.

FIG. 5 is a fifth embodiment of the disposable mass transfer system according to the present invention having two semi-rigid or rigid tubular enclosures in parallel.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

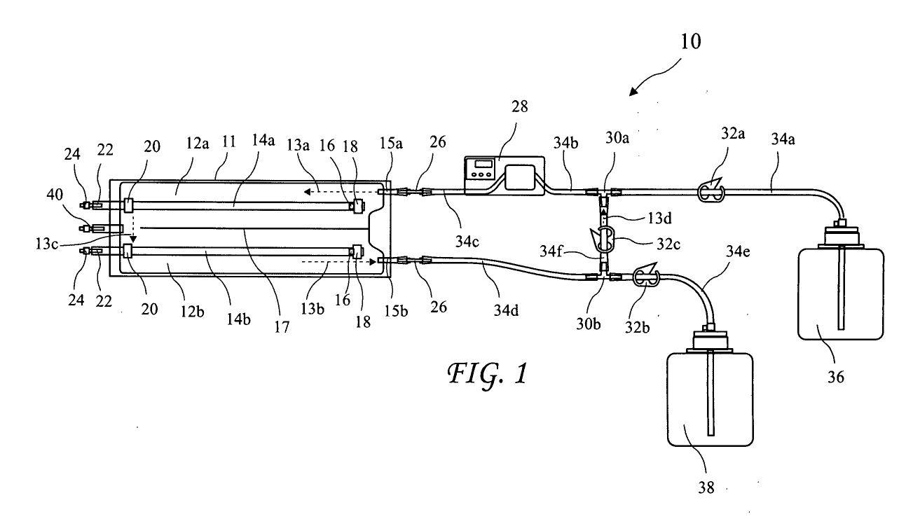

A disposable mass transfer system 10 according to the present invention is shown in FIG. 1. The disposable mass transfer system 10 includes semi-permeable tubular membranes 14a and 14b longitudinally disposed substantially (i.e., all or mostly) within sealed fluid flow channels 12a and 12b respectively. Either a portion of the semi-permeable tubular membranes 14a, 14b must extend from the sealed fluid flow channels 12a and 12b to provide a port for providing access to an interior of the semi-permeable membrane, or access to the semi-permeable tubular membranes 14a, 14b must be provided through the sealed fluid flow channels 12a and 12b to the port.

The sealed fluid flow channels 12a and 12b reside in (or are formed by) a flexible sealed reservoir (dialysis chamber) 11, or in other embodiments, the sealed fluid flow channels 12a and 12b may comprise tubes. Each of the sealed fluid flow channels 12a and 12b contain at least one of the semi-permeable tubular membranes 14a, 14b, and the channels 12a and 12b fluidly cooperate to create a sequentially flow through the channels 12a and 12b. The semi-permeable tubular membranes 14a, 14b are preferably regenerated cellulose tubing preferably with a flat width ranging between approximately 3 mm and 340 mm and more preferable with a flat width ranging between approximately 8 mm and approximately 16 mm. The flexible sealed reservoir 11 is preferably made from PVC and the flow channels 12a and 12b are integrally formed in the flexible sealed reservoir 11 by RF welding, wherein a wall 17 separates the channels 12a and 12b.

The flexible plastic reservoir 11 includes hermetically sealed fluid inlet and outlet ports 15a and 15b respectfully, to allow connection of the flow channels 12a and 12b to external tubing 34c and 34d respectively using tube to tube connectors 26. The external tubing 34c carries a first (or inlet) flow of dialysis fluid 13a (or mass transfer exchange fluid) into the channel 12a, and the external tubing 34d carries a second (or outlet) flow of dialysis fluid 13b out of the flow channel 12b. The dialysis fluid circulates from the chamber 12a into the chamber 12b in a third flow of dialysis fluid 13c. The first flow of dialysis fluid 13a may be fresh dialysis fluid, or may be partially spent dialysis fluid being re-circulated as described below. The second flow of dialysis fluid 13b may be partially spent dialysis fluid suitable for re-circulating as described below, or may be fully spent dialysis fluid. The flows 13a and 13b circulate tangentially along outer surfaces of the semi-permeable tubular membranes 14a and 14b.

The port 15a receives the fresh dialysis fluid from a source of dialysis fluid 36 through serially connected tube 34a, tube 34b, pump 28, and the tube 34c (i.e., through inlet tubes). The outlet port 15b releases spent dialysis fluid to a waste fluid reservoir 38 through serially connected tube 34d and tube 34e (i.e., through outlet tubes). The source of dialysis fluid 36 is preferably a bulk reservoir container (for example a bottle) and the waste fluid reservoir 38 is preferably a waste reservoir container. The pump 28 provides propulsion of dialysis fluid through the tubing 34a-34c, through the flow channels 12a and 12b, through the tubing 34d and 34e, and into the waste fluid reservoir 38.

The port 15a may also receive the partially spent dialysis fluid through serially connected tube 34d, tube 34f, tube 34b, pump 28, and tube 34c, thereby re-circulating the partially spent dialysis fluid through the sequentially connected flow channels 12a and 12b. The tube 34f is a shunt tube carrying a shunt flow 13d and is connected between the inlet tubes and the outlet tubes to provide the re-circulating, and preferably the tube 34f is connected between the tubes 34a and 34b by a first “T” 30a and is connected between the tubes 34d and 34e by a second “T” 30b. The pump 28 is preferably a peristaltic pump and the tubes 34b and 34c are preferably a single continuous tube.

A first pinch clamp 32a resides on the tube 34a, a second pinch clamp 32b resides on the tube 34e, and a third pinch clamp 32c resides on the tube 34f. The pinch clamp 32c may be used to pinch (i.e., close) tube 34f, thereby connecting the source of dialysis fluid 36 to the flow channels 12a and 12b through the pump 28, and connecting the flow channels 12a and 12b to the waste fluid reservoir 38. Alternatively, the pinch clamps 32a and 32b may be used to pinch the tubes 34a and 34e, thereby connecting the pump 28 to re-circulate the partially spent dialysis fluid. While pinch clamps 32a-32c is preferred, any suitable on-off valve or clamp may be used to selectively block or clamp the tubes 34a, 34e, and 34f.

The semi-permeable tubular membranes 14a, 14b have an open end and a closed end. The closed ends are preferably sealed by plugs 16 held in place by a sleeve and collet 18. An example of a suitable plug 16 is a part number AP01PLG25P made by ARK-PLAS INC. in Flippin, Ark. An example of a suitable sleeve and collet is a part number BL135250W made by Barblock in Traverse City, Mich. A conduit 22 is connected to the open end of each of the semi-permeable tubular membranes 14a, 14b. The conduit members 22 preferably have one end hermetically sealed to the semi-permeable tubular membranes 14a, 14b by plastic needleless access injection port fittings. The conduit members 22 pass through the walls of the flexible sealed reservoir 11 and the flow channels 12a and 12b and connect to hermetically sealed needleless injection access sites 24. An example of a suitable needleless connection site is a part number 8014F made by QOSINA in Edgewood, N.Y. The conduit members 22 are preferably sealed to the walls of the flexible plastic reservoir 11 by heat sealing. The access sites 24 are preferably able to allow access to the interior space of the semi-permeable tubular membranes 14a, 14b by a hypodermic needle and preferably allow access using other needleless access means. Further, the flexible plastic reservoirs 11 is provided with a third, hermetically sealed access site 40 to serve as means to access the interior cavities of said reservoir.

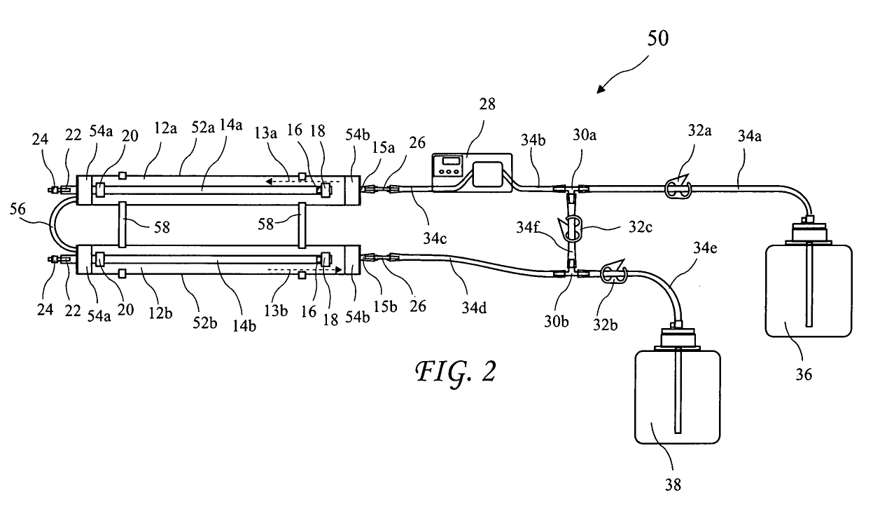

A second disposable mass transfer system 50, includes the fluid flow channels 12a and 12b comprising semi-rigid or rigid tubular enclosures 52a and 52b, and preferably a clear medical grade plastic resin such as PVC, polycarbonate, Lexan® resin, polysulfone and the like, containing the tubular semi-permeable membranes 14a and 14b as shown in FIG. 2. The semi-rigid or rigid tubular enclosures 52a and 52b may be (but are not necessarily) sequentially connected and in fluid communication with one another by a flexible or rigid by-pass tube 56 to provide sequential fluid communication between the first fluid flow channel 12a and the second fluid flow channel 12b. Silicone stoppers 54a (having two holes) and 54b (having a single hole) seal ends of tubes to form the fluid flow channels 12a and 12b. The disposable mass transfer system 50 is otherwise similar to the disposable mass transfer system 10.

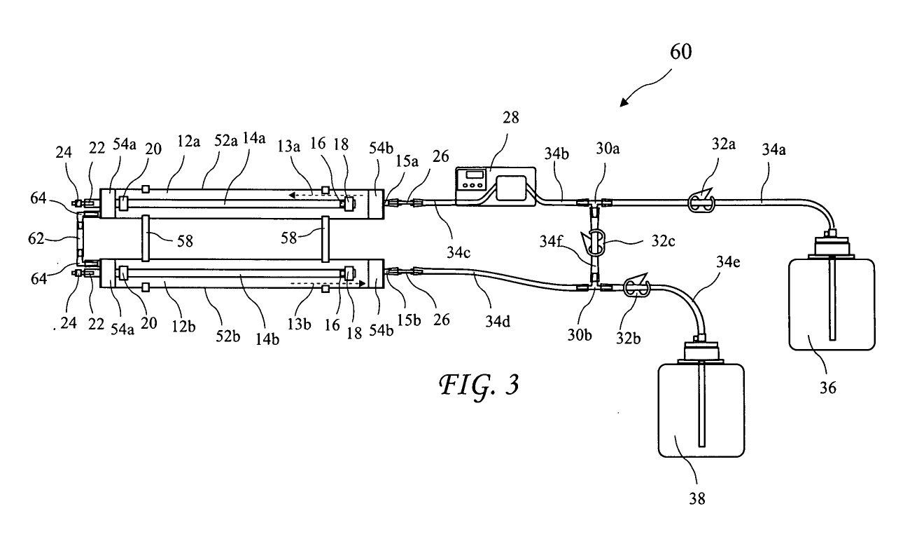

A third disposable mass transfer system 60 includes the fluid flow channels 12a and 12b comprising the semi-rigid or rigid tubular enclosures 52a and 52b containing the tubular semi-permeable membranes 14a and 14b as shown in FIG. 3. The semi-rigid or rigid tubular enclosures 52a and 52b are sequentially interconnected in fluid communication with one another by elbows 64 connected by tubing 62. The disposable mass transfer system 60 is otherwise similar to the disposable mass transfer system 50.

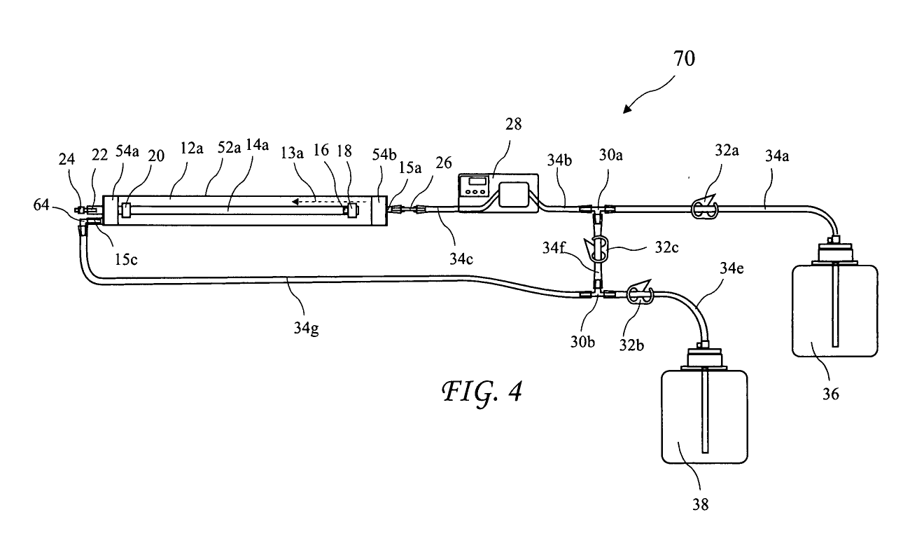

A fourth disposable mass transfer system 70 includes a single channel 12a comprising the semi-rigid or rigid tubular enclosure 52a containing the tubular semi-permeable membrane 14a as shown in FIG. 4. A second outlet port 15c is provided opposite the port 15a to allow circulation of the dialysis fluid through the enclosure 52a. The disposable mass transfer system 70 is otherwise similar to the disposable mass transfer system 50.

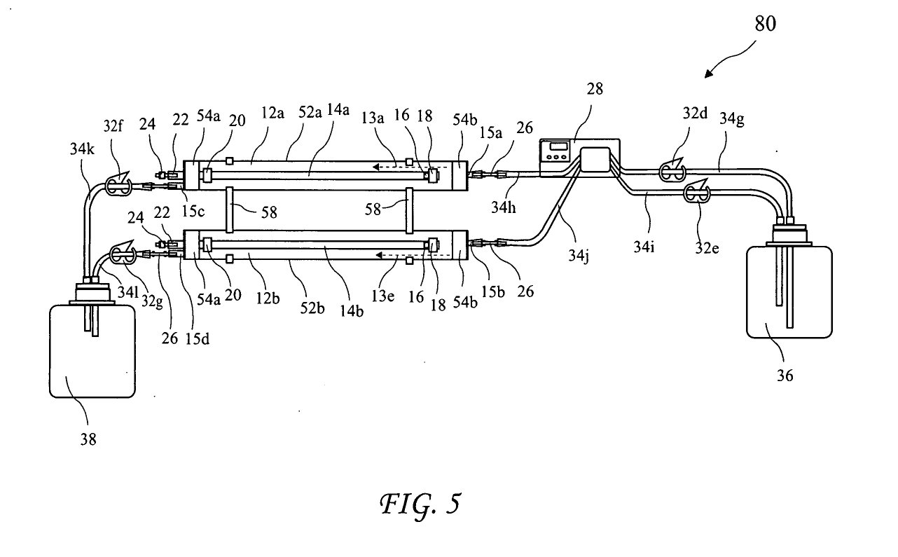

A fifth embodiment of the disposable mass transfer system 80 according to the present invention, having two semi-rigid or rigid tubular enclosures 52a and 52b in parallel, is shown in FIG. 5. Tubes 34g and 34h (which may be a single continuous tube when the pump 28 is a peristaltic pump) connect the source of dialysis fluid 36 to the enclosure 52a, and similarly, tubes 34i and 34j connect the source of dialysis fluid 36 to the enclosure 52b. Pinch clamps 32d and 32e residing on the tubes 34g and 34i control flows through tubes 34g and 34i respectively, thereby providing independently controllable parallel flows of dialysis fluid 13a and 13e through the enclosures 52a and 52b.

The tube 34h is connected to the port 15a by a tube connector 26 and the tube 34j is connected to the port 15b by another tube connector 26. Tubes 34k and 34l connect outlet ports 15c and 15d of the enclosures 52a and 52b respectively to the waste fluid reservoir 38. Pinch clamps 32f and 32g reside on tubes 34k and 34l respectively and may be used to control a flow through the tubes 34k and 34l. The disposable mass transfer system 80 is otherwise similar to the disposable mass transfer system 50.

The disposable mass transfer systems 50, 60, 70, and 80 may further be expanded into a multiplicity of sequentially connected semi-rigid or rigid tubular enclosures, and an individual semi-rigid or rigid tubular enclosures may be enlarged to contain more than one tubular semi-permeable membranes.

Typical dialysis applications include desalting, concentrating plasma or serum, buffer and pH change of sample solution, preparation of diluted proteins prior to electrophoresis, concentration of antibodies, contamination removal, binding studies, batch analysis temperature regulated dialysis, tissue culture extract purification, protein removal from gels after electrophoresis removal of olizosaccharides from protein solutions. These are examples of typical applications for the invention. (Ref. The ABCs of Filtration and Bioprocessing for the Third Millennium, page 68, by Ballew, Martinez, Markee, and Eddleman).

While the invention herein disclosed has been described by means of specific embodiments and applications thereof, numerous modifications and variations could be made thereto by those skilled in the art without departing from the scope of the invention set forth in the claims.

I claim:

1. A disposable dialysis system comprising:
at least one fluid flow channel having an inlet port and an outlet port;
at least one semi-permeable membrane residing substantially within the at least one fluid flow channel, one end of the semi-permeable membrane having a port for providing access to an interior of the semi-permeable membrane;
a pump;
a dialysis fluid source;
a spent dialysis fluid reservoir;
inlet tubes fluidly connecting the dialysis fluid source to an inlet port of one of the at least one flow channel; and
outlet tubes fluidly connecting-an outlet port of one of the at least one flow channel to the spent dialysis fluid reservoir,
wherein the pump cooperates with one of the group consisting of the inlet tubes and the outlet tubes to provide propulsion to dialysis fluid in the tubes.

2. The disposable dialysis system of claim 1, further including a shunt tube connected between the inlet tubes and the outlet tubes to a re-circulation circuit including the pump to re-circulate partially spent dialysis fluid though the at least one fluid flow channel.

3. The disposable dialysis system of claim 2, wherein the shunt tube is connected to the inlet tubes by a first “T” and the shunt tube is connected to the outlet tubes by a second “T”, and further including a first on/off valve between the dialysis fluid source and the first “T” and a second on/off valve between the second “T” and the spent dialysis fluid reservoir, and a third on/off valve on the shunt tube between the “T”s.

4. The disposable dialysis system of claim 3, wherein on/off valves are pinch clamps.

5. The disposable dialysis system of claim 1, wherein the at least one fluid flow channel is formed in a flexible sealed reservoir.

6. The disposable dialysis system of claim 1, wherein the at least one fluid flow channel is selected from the group consisting of semi-rigid or rigid enclosures.

7. The disposable dialysis system of claim 6, wherein the semi-rigid enclosures and the rigid enclosures are cylinders.

8. The disposable dialysis system of claim 1, wherein the least one semi-permeable membrane is longitudinally disposed within the at least one fluid flow channel.

9. The disposable dialysis system of claim 1, wherein
the at least one semi-permeable membrane comprises two semi-permeable membranes and the at least one fluid flow channel comprises two fluid flow channels; and
the two fluid flow channel are sequentially fluidly connected to provide a sequential flow of fluid through the two fluid flow channels.

10. The disposable dialysis system of claim 1, wherein at least one fluid flow channel comprises two fluid flow channels in parallel.

11. A disposable dialysis system comprising:
two sequentially connected fluid flow channels having an inlet port and an outlet port;
two semi-permeable membranes, one residing substantially within each of the fluid flow channels, an exposed end of each of the semi-permeable membranes having a port for providing access to an interior of the semi-permeable membranes;
a dialysis fluid source;
a spent dialysis fluid reservoir;
inlet tubes fluidly connecting the dialysis fluid source to the inlet port;
outlet tubes fluidly connecting the outlet port and the spent dialysis fluid reservoir;
a shunt tube fluidly connected between the inlet tubes and the outlet tubes by a first “T” residing in series with the inlet tubes and a second “T” residing in series with the outlet tubes.
a pump residing between one of the “T”s and one of the inlet port and the outlet port; and
a first on/off valve cooperating with the inlet tubes between the dialysis fluid source and the first “T” to control an inlet flow, a second on/off valve cooperating with the outlet tubes between the second “T” and the spent dialysis fluid reservoir to control an outlet flow, and a third on/off valve cooperating with the shunt tube between the “T”s to control a shunt flow,
wherein the pump cooperates with one of the group consisting of the inlet tubes and the outlet tubes to provide propulsion to dialysis fluid in the tubes.

12. A disposable dialysis system comprising:
a fluid flow channel having an inlet port and an outlet port;
a semi-permeable membrane residing substantially within the fluid flow channel, an exposed end of the semi-permeable membrane having a port for providing access to an interior of the semi-permeable membrane;
a dialysis fluid source;
a spent dialysis fluid reservoir;
inlet tubes fluidly connecting the dialysis fluid source to the inlet port;
outlet tubes fluidly connecting the outlet port and the spent dialysis fluid reservoir;
a shunt tube fluidly connected between the inlet tubes and the outlet tubes by a first “T” residing in series with the inlet tubes and a second “T” residing in series with the outlet tubes.
a pump residing between one of the “T”s and one of the inlet port and the outlet port; and
a first on/off valve cooperating with the inlet tubes between the dialysis fluid source and the first “T” to control an inlet flow, a second on/off valve cooperating with the outlet tubes between the second “T” and the spent dialysis fluid reservoir to control an outlet flow, and a third on/off valve cooperating with the shunt tube between the “T”s to control a shunt flow,
wherein the pump cooperates with one of the group consisting of the inlet tubes and the outlet tubes to provide propulsion to dialysis fluid in the tubes.
